(19) United States
(12) Patent Application Publication
(10) Pub. No.: US 2011/0141148 A1
(43) Pub. Date: Jun. 16, 2011

(54) Image Reproduction Method Featuring Additive Color Mixing from More than Three Color Channels

(76) Inventors: Bernhard Hill, Aachen (DE); Thomas Boosmann, Telgte-Westbeveren (DE)

(21) Appl. No.: 12/297,397

(22) PCT Filed: Apr. 10, 2007
(86) PCT No.: PCT/EP2007/003175

§ 371 Date: Mar. 3, 2011

(30) Foreign Application Priority Data
Apr. 17, 2006 (DE) 10 2006 018 218.9

(51) Int. Cl. G09G 5/10

(52) U.S. Cl. 345/690

(57) ABSTRACT

The invention relates to a method for triggering an electronic image reproduction device comprising N>3 individually controlled color channels, by means of which N primary colors are defined, the colors being additively mixed from said N primary colors. One or several pre-calculated two-dimensional tables, in which the values required for controlling N color channels are stored under the addresses of a color type of the colors that are to be reproduced and are retrieved during operation, are used for real-time processing.

The invention relates to a procedure for triggering an electronic pictorial representation device, whereby the pictorial representation device is operated with N>3 individually adjustable color channels, the reproduced colors are implemented via an additive mixture of N color channels with N assigned primary valences (basic colors of the pictorial representation device), and optionally an additional brightening of the perceived color is controlled by a white brightening channel.

For example, with DLP projectors for color depiction of three color channels it is often customary to use a fourth channel for white light. The fourth channel serves for brightening with depiction of text. At least on the market, projectors for more than three color channels are not usual. By color channels what we mean here are the actual color ones, thus spectrally selective and not white channels. From the publication by Moon-Cheol Kim et al, “Wide Gamut Multi-Primary Display for HDTV,” Proc. CGIV 2004, The Second European Conference on Colour in Graphics, Imaging and Vision, IS&T, Springfield, Va., USA 2004, ISBN 0-89208-250×, pp. 248-253, a filter wheel projector by Samsung with 5 narrow-band color channels is known, in which color mixing takes place by using a modified procedure that originally was disclosed in T. Ajito, K. Ohsawa, T. Obi, M. Yamaguchi, N. Ohyama, “Color conversion method for multiprimary display using matrix switching,” Optical Review, vol. 8, no. 3, 2001, pp. 191-197. With this the depicted color space of the projection system is divided into pyramids with a rectangular base surface, whereby the tips of the pyramids end in a common black point of the color body. Within a pyramid, the colors are mixed from the mixture of three base colors, that are defined as a tripod by 2 edges of the base surface of each pyramid and one edge from there to the black point. Thus the color mixing within each pyramid is directed back to the mixing of three basic colors, and can take place in a known manner by solving three equations for three color values. The three basic colors that each define a pyramid, are either pure primary colors of the projection system or a superposition of these with a fixed amplitude relation among each other. The triggering of the projection system is determined for each of these pyramids independent of a determination for one other color, that is within another pyramid in the color space. For the selection of a pyramid that is to be consulted for the computation, in the original publication a projection takes place into a color table, here the standard color table of the CIE. With this the color table is stored as a lookup table (LUT) in which for each color value share that is to be reproduced, the pertinent pyramid is entered. In the modified version, this selection occurs via a linear determination equation which describes the edges of the particular pyramid.

The disadvantages of this procedure consist for one in the lack of an option to adapt this color depiction to various observers, color or spectral classes, although precisely for this the greater number of degrees of freedom is offered for color mixing. For another, in the processing of the color data in the modified version, a whole series of computing operations are necessary, which complicate processing of the color data in real time.

To supplement we refer to the following publications:
F. König, N. Ohyama, B. Hill, K. Ohsawa, M. Yamaguchi, “A multiprimary display: optimized control values for displaying tristimulus values, Image Processing, Image Quality and Image Systemes Conference PICS, Portland, Oreg., Apr. 7-10, 2002.
F. König, N. Ohyama, M. Yamaguchi, N. Ohyama, B. Hill, “A multiprimary display: discounting observer metamerism,” Proceedings of the 9^{th} Congress of the International Colour Association (AIC Color O1), Rochester, N.Y., Jun. 24-29, 2001, Proc. SPIE Vol. 4421, 2002, pp. 898-901.
H. Motomura, H. Haneishi, M. Yamaguchi, N. Ohyama, “Backward model for multi-primary display using linear interpolation on equi-luminance plane,” Proceedings of IS&T's 10^{th} Color Imaging Conference Color Science and Engineering Systems, Technologies, Applications, Scottsdale, Ariz., Nov. 12, 2002, pp. 267-271.
K. Ohsawa, F. König, M. Yamaguchi, N. Ohyama, “Multi-primary display optimized for CIE 1931 and CIE 1964 color matching functions,” Proceedings of the 9^{th} Congress of the International Colour Association (AIC Color O1), Rochester, N.Y., Jun. 24-29, 2001, Proc. SPIE Vol. 4421, 2002, pp. 939-942.
T. Uchiyama, M. Yamaguchi, H. Haneishi, N. Ohyama, “A visual evaluation of the image reproduced by color decomposition based on spectral approximation for multiprimary display,” Proceedings of the 2^{nd} European Conference on Color in Graphics, Imaging and Vision CGIV 2004, Aachen, Germany, Apr. 5-8, 2004, pp. 281-285.

In these publications, procedures are proposed for a direct computation of color depictions with more than three color channels. In doing so, for one, complex algorithms are used, so that with the computation such long computing times are needed that they currently cannot be applied online and at justifiable costs. For another, we are dealing with simple linear representations that, for a high quality color reproduction, have a too-high color reproduction error for various observers, and do not make possible any adaptation to a group of observers.

Therefore, the content of the invention is a procedure to trigger an image reproduction device with more than three color channels, which can implement individual control of the color channels online and in addition permits flexible adaptation options of color reproduction to various observers.

This problem is solved by the features of the individual patent claims. Advantageous further embodiments of the invention are the subject of the subordinate claims.

The inventors propose control of more than three narrow-band color channels of an image reproduction device to reproduced spectral color stimuli or color values in XYZ or RGB for large color spaces by an arrangement of single or multiple tables. For this, using a two-dimensional table of color type values computed before operation of the image reproduction device, particularly great image setup speed can be achieved. Only one table access and a few simple computing operations per image point are required for the setup of more than three, for example six, color separations. The table can be precomputed a single time, for example, using the procedure that is described in what follows. Through this it is possible to adapt the perceived color of a digital image reproduction device individually to multiple specific observers or a group of observers, without the otherwise required computing time precluding on-line processing. By the use of multiple tables that are precomputed according to various optimization criteria, rapid and flexible adaptation of the color reproduction is made possible according to selection criteria.

Accordingly, the inventors propose a procedure for triggering an electronic image reproduction device, in with the image reproduction device is run with N>3 individually adjustable color channels, and in which the reproduced colors are reproduced via an additive mixing of N color channels with N assigned primary valences (base colors), whereby optionally an additional brightening of the perceived color can be controlled by a white brightening channel. The invention-specific improvement of this process lies in the fact that before operation, at least one LUT is compiled, whose addresses correspond to a color type, and under each address, a control vector with N control signals for the control of the N channels of the screen is stored at maximum possible brightness for this color type, and in operation, for control of the N color channels for a color of a given brightness to be reproduced, first the color type is computed, so that the LUT can be addressed, and the control vector of the LUT found at this address is used for the control signals for the N color channels.

With this it can be advantageous if the LUT can be addressed two-dimensionally via the color types {u′,v′} of the CIE 1976 UCS color table. However, other color tables with other definitions of their color type can also be used.

Additionally, with the application of this procedure, an internal linearization for a linear connection between input signals of the image reproduction device and the generated color values should be used, so that these influences can be kept away from the computation of the LUT and the processing of color vectors.

Additionally, the inventors propose that before operation, a pertinent maximum brightness value be stored in the LUT under the addresses of the color types, and in operation, for controlling the N color channels, the control vector of the LUT be multiplied at this address by the relationship of the given brightness of the color to the stored maximum brightness value, and thus issued as control signals for the N color channels.

It can also be advantageous if the particular maximum brightness value for the color type is computed according to the basic spectral value curves of a given observer from the stored control values and according to a reproduction model of the screen.

With this procedure, it is now possible in the LUT to determine the color types for a multiplicity of defined observers, whereby the observers are defined from their individual basic spectral value curves. Especially favorable for technical applications herein is if at least one defined observer is the CIE normal observer (2° observer).

A possibility also exists to compile one's own LUTs with a one-time computing effort for image types with a special color or spectral characteristic, such as very saturated floral colors, and to store them in parallel, so that later, in operation, depending on the recognized image type, the control vectors can be derived from the corresponding LUT.

Additionally, with this procedure, an LUT can be compiled for various observers and stored in parallel, and depending on the observer or group of observers present, the control vectors can be derived from the corresponding LUT.

Another very advantageous embodiment consists in addressing—in parallel—multiple tables which are precomputed and optimized according to various criteria, and from the particular issued control vectors, with a model of the color reproduction system, to select the control vector that leads to minimal color production errors for a group of observers.

For precomputation of the tables, particularly the triggering vectors stored in the LUT can be derived from the weighted superposition of solutions for mixing the color type from three primary screen colors, and this weighted superposition of solutions from all possible combinations of three primary colors can be optimized so that a maximum possible brightness with the given color type is achieved, and/or a minimization of the color reproduction errors for a group of observers is computed. For example, iteration or linear programming can be used for the optimization.

The control vectors for a color type can also be determined with the particular maximum possible brightness of the reproduced color from triangles on the surface of the color body of a screen, whereby the corners of the triangles are given via extreme points, which are determined through the mixing of the primary colors of a number of K color channels with 1≦K≦N with full triggering.

The spectral distributions of the K color channels lie next to each other in the spectral region and all other (N−K) color channels are switched out. With this the color channels at the edges of the visual region closed via the infinite are likewise to be seen as adjacent.

Additionally, for prescribed classes of spectral distributions of colors to be reproduced, proceeding from a starting vector, a stochastic optimization of the triggering values can be carried out according to the minimum color error for a group of observers, and the start vector can be computed from a simple linear solution for an average observer as described above, or through adaptation of the reproduced spectrum from the model of color reproduction to a preset spectral color stimulus function according to the least error square. With this version of the procedure, we also propose that the group of observers correspond to a representative cross section of human observers.

We draw attention to the fact that not merely the procedure described above is within the scope of the invention, but also methods, especially computer programs in connection with computing units that are modeled on this procedure in operation. Also belonging to the scope of the invention are storage media that are integrated into a computing unit of an image reproduction device or are meant for a computing unit of an image reproduction device, and contain a computer program or program modules, which with one embodiment, carry out the above-described procedure in full or in part on a computing unit.

In what follows, the invention-specific procedure is described in greater detail with the aid of figures, where only the features necessary to understand the invention are depicted. Shown in particular are:

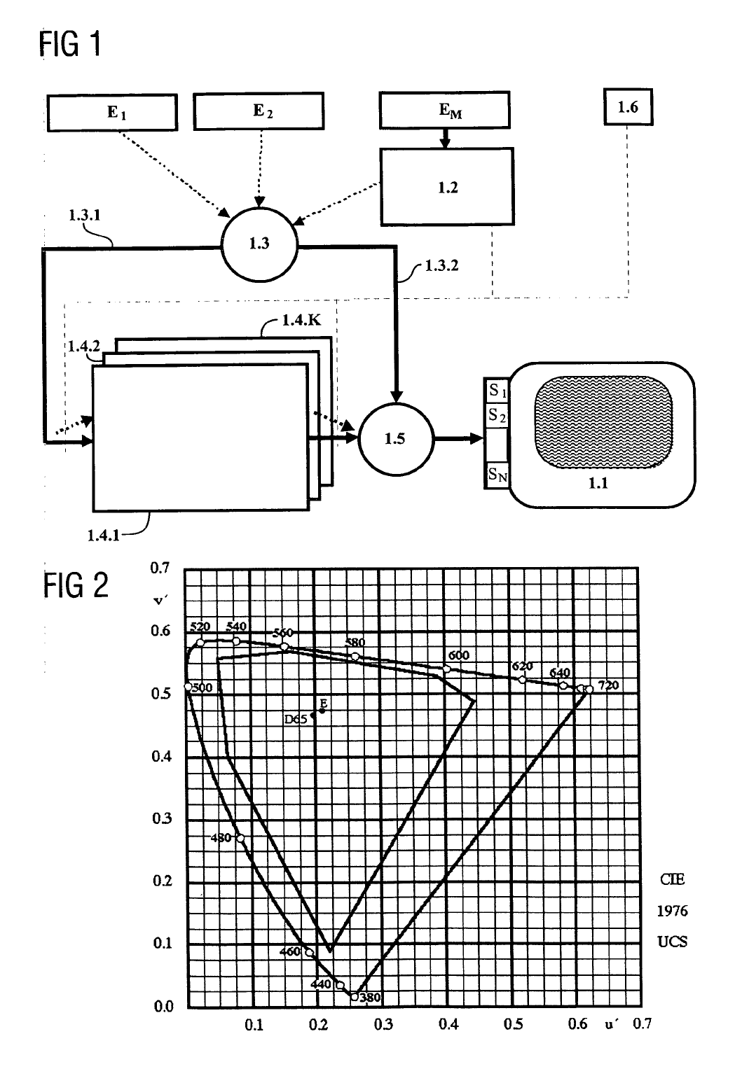

FIG. 1: an overview of the entire system of image reproduction

FIG. 2: a CIE 1976 UCS color table with color areas drawn in of a color reproduction with 6 primary colors

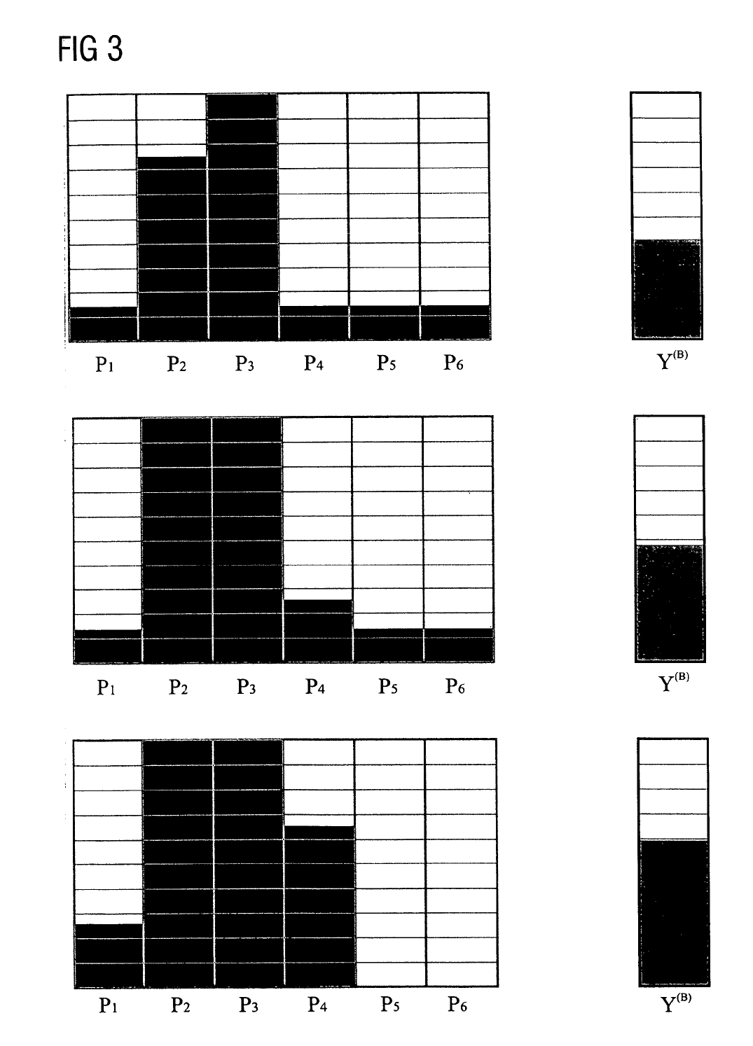

FIG. 3: an example of an iterative buildup of amplitudes of the control signals

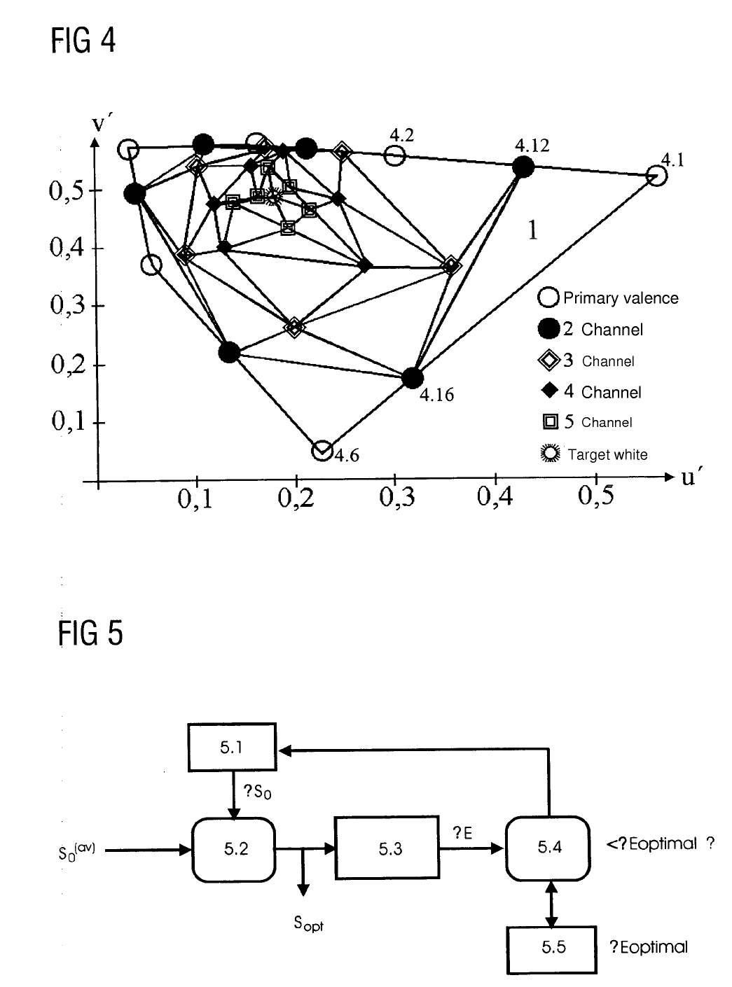

FIG. 4: a division of the CIE 1976 UCS color table into partial areas in triangular form

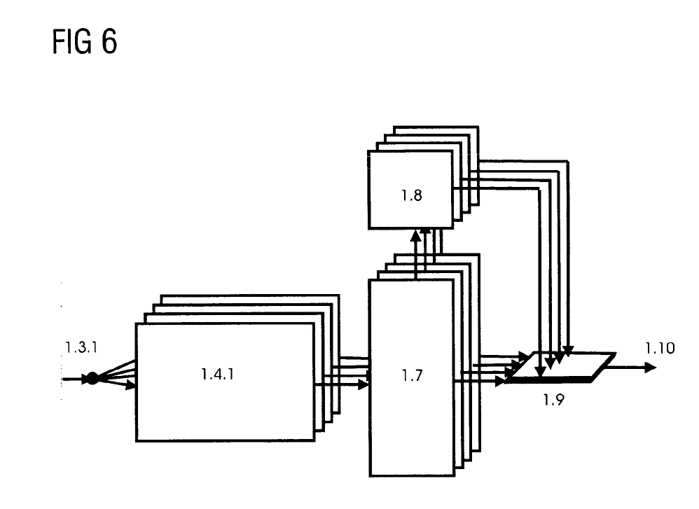

FIG. 5: a diagram of a stochastic optimization of triggering values

FIG. 6: a diagram of minimizing color errors from control values of multiple tables

In what follows, the invention-specific procedure for control of color screens with more than three color channels will be described in detail. While doing so, it is based, while not limiting the generality, on an image reproduction device in the form of a color screen that operates with N color channels and with N primary valences of the color channels and mixes the color in each image point of an image by additive mixing of the primary colors.

The primary colors are designated with P_{1 . . . N}^{(B)}, and it is assumed that control of luminance of each primary color on the screen is internally linearized, i.e., that the generated luminance in each channel follows linearly the particular control signal Sᵢ with i of 1 to N at the entrance of each screen channel. FIG. 1 depicts the basic diagram of the screen control. The screen is shown schematically by block 1.1.

The primary colors are defined in known fashion from the spectral distribution of the luminous radiation generated through each channel on the screen, assessed with the three basic spectral value curves of an observer such as the defined CIE 1931 normal observer. The primary valences are described in connection with this through three color values such as X, Y and Z. However, according to the invention, the spectral value curves of other observers can also be consulted for defining the primary valences, which differ in the spectral range from those of the CIE 1931 normal observer or those based on another viewing angle. With a selection of representative observers, the differences in human color vision that are present in practice can also be allowed for.

For an observer B defined by its basic spectral value curves, the mixable color F^{(B)} can be described by the equation:

*F^{(B)}=S₁^{(B)}P₁^{(B)}+S₂^{(B)}P₂^{(B)}+ . . . +S_{N}^{(B)}P_{N}^{(B)}

Here the primary colors are defined for the full triggering of each channel. If we summarize the control values S₁ to S_{N} into a vector and the primary colors P₁^{(B)} to P_{N}^{(B)} into a matrix, then the above equation can also be written in vector form:

*F^{(B)}=P^{(B)}*S^{(B)}mitP₂^{(B)}={P₁^{(B)},P₂^{(B)}, . . . P_{N}^{(B)}},S^{T}={S₁^{(B)},S_{S}^{(B)}, . . . S_{N}^{(B)}} and Pᵢ^{(B)}={Xᵢ^{(B)}, Yᵢ^{(B)},Zᵢ^{(B)}}^{T}.

For a current state-of-the-art screen with N=3 color channels, the control signals are often characterized as RGB signals. These can then be computed for the mixed color with their three color components such as the components X, Y and Z, according to the defined CIE 1931 normal observer, through an exact solution of the above equation from the control signals. For the mixture of N=3 color channels, thus for each observer B, there results an unambiguous solution for the required control signals, with which a certain color F must be mixed:

*S={P^{(B)}}⁻¹*F^{(B)}

In image technology, only the CIE 1931 normal observer is viewed as corresponding to the current state of the art.

As is evident from the above equations, for the adaptation of the color reproduction to any human observer B, in each case a signal vector must be used that differs from that of another observer. If a screen only of the CIE 1931 normal observer is assumed for the control, the corresponding mixed colors for other observers are no longer true to the original.

If a screen is now used that mixes the colors from more than three channels, then more degrees of freedom are available for the adaptation of the color reproduction, which can be used to achieve a color reproduction true to the original for more than one observer. If, for example, N=6 color channels are present, than the colors can be exactly adapted for two different observers, since with each three color values of each observer, 6 equations are available. However, in addition it has been shown that already with 6 color channels, a good adaptation is possible to a still greater number of different observers, in such a way that for all possible colors the maximum color errors are in the range of barely visible color differences. For example, one can proceed from the assumption of a number of typical observers that constitute a representative cross section. If the number of color channels is very large, such as N>10, also the color reproduction can be spectrally adapted directly to pre-set spectral color stimuli. In this case, a direct formation of signals is possible from N weighted spectral bands of the input spectrum, which can be formed via a simple linear algorithm.

One difficulty in practice is that such an adaptation and optimization of the color reproduction with more than three color channels requires a relatively complex computation, which cannot be used in real time for an image representation. Fast triggering for real-time processing of image data requires either a very simple algorithm or a precomputed table, from which the triggering values can be retrieved via a suitable addressing. With a simple algorithm, such as a simple mathematical matrix operation, as in the case of three color channels, the problem of color control of 6 color channels, for example, cannot be solved satisfactorily due to underdeterminacy. On the other hand, a general multi-dimensional table for an N-dimensional space is extraordinarily voluminous. If we for example assume 6 input color values from two different observers, for which the colors are to be reproduced exactly, then, with only 8 support points per triggering value, a table with 8⁶=262,144 entries would be necessary.

Therefore, according to the invention a triggering procedure is proposed, which, exploiting the linearity of the N color channels, uses only one two-dimensional addressed table, in which under each address a signal vector is stored for N channels for the maximum attainable brightness Y^{(B)}ₘₐₓ for a defined observer along with this one. As an alternative, we can also dispense with this storage of the maximum attainable brightness Y^{(B)}ₘₐₓ. From the triggering values for the maximum brightness, the model of the screen, which describes the connection between control signals and the spectral distribution of the depicted color channels, and an assumed observer, the maximum brightness value can also be computed. Naturally, this requires additional computing time. The table is defined as a color type table, such as a color type table as per the definition of the CIE 1976 UCS color table, in which the addresses of a color type {u′,v′} for the CIE 1931 normal observer are assigned. Deviating from the norm, according to the invention it can also be assumed that the color type is defined for deviating observers. For example, an average observer from a set of representative observers can be defined as the reference observer. If one such table is selected for a resolution of 10 bits per color type for a screen with 6 color channels, than under about one million addresses, 7 values each for the 6 control signals and the maximum brightness, in 10-bit resolution, for example, are to be stored. This can be implemented by current-day computer technology with no difficulties. Intermediate values between the addresses can then be formed via a linear interpolation. Investigations have shown that this example yields a precision that leads to color errors no longer visible through the quantization.

Filling in the table requires computational algorithms with a large expenditure of time, that for one thing can be adapted to certain observers, and for another should also take into account certain color classes depending on the spectral color stimuli of the original spectra of the colors to be depicted, if we proceed from spectral input signals. However, these computations, depending on the application case, are to be carried out only once, and the results are then available for a multiple application when operating the screen. Therefore, according to the invention, the triggering procedure is structured according to FIG. 1. By way of the inputs E₁ to E_{M}, variously defined input signals can be fed in. These can be according to a standard of defined color signals like sRGB, the expanded color space bg-SRGB or XYZ signals for a normal or average observer, or also multispectral signals such as E_{M}, that describe the spectral color stimulus of original signals. If multispectral signals exist, these can be transferred according to an algorithm that will be described later in more detail to block 1.2 in color signals. According to the invention, from each offered color signal in block 1.3 a color type signal is formed such as {u′,v′} according to the formulas of the CIE 1976 UCS color table used as an example:

{u′v′}={4X^{(B)},9Y^{(B)}}/(X^{(B)}+15Y^{(B)}+3Z^{(B)})

as well as extracting the brightness Y^{(B)} that results for a defined observer. The values X^{(B)}, Y^{(B)} and Z^{(B)} represent the color values for a selected observer, if x(1)^{(B)}, y(1)^{(B)} and z(1)^{(B)} represent the spectral value curves of any observer B, and a color is described by the spectral color stimulus φ_{λ}. The color values {X^{(B)}, Y^{(B)}, Z^{(B)}} follow from the following relations:

X^{(B)}=k₀∫φ_{λ}x(1)^{(B)}dλ; Y^{(B)}=k₀ƒφ_{λ}y(1)^{(B)}dλ; Z^{(B)}=k₀∫φ_{λ}z(1)^{(B)}dλ

where the constant k₀ is determined from a spectral color stimulus with Y_{white}=1.0. The integration range extends over the entire visible spectrum, preferably from λ=380 to 780 nm.

The {u′,v′} components are led via the path 1.3.1 in FIG. 1 to the addresses of color tables 1.4, while the brightness value is brought via path 1.3.2 to the multiplier 1.5.

With the color signal, a two-dimensional table 1.4.1 is addressed. This emits N output signal values for the maximum brightness Y^{(B)}ₘₐₓ attainable with the screen. These signal values are then merely multiplied in processing block 1.5 by the factor Y^{(B)}/Y^{(B)}ₘₐₓ before they are fed to the input S of the screen. Thus for each input signal, the control signal can be computed using only two simple mathematical operations and one table access. In practice, this is possible in real time processing at very high speed.

For adaptation to various observer groups or to certain classes of spectral color stimuli, more tables 1 to K can also be used in parallel, which are selected as desired using a selection parameter 1.6. They can be selected by image point or in lump-sum fashion for an entire image, and are pre-set in lump-sum fashion for standardized input signals via input 1.6, or if necessary they are also generated in image-point fashion for spectral input signals in processing block 1.2.

Another advantageous embodiment can be done as per FIG. 6, in that the parallel-arrayed tables 1 to K are addressed simultaneously with a desired color type 1.3.1, and their control signals are then transferred at the output in parallel or sequentially using a model of color reproduction for a group of various observers in color values XYZ (block 1.7), from which then maximal color reproduction errors Δeₘₐₓ of all observers are computed in a known manner (block 1.8) and then the control vector 1.10 is selected (block 1.9), that leads to the least color reproduction error Δeₘₐₓ of all observers. The selected control vector 1.10 is then fed to the image reproduction device. For example, for the error computation, the known formulas for ΔE*_{ab} (CIEΔE 1976), ΔE*₉₄ (CIE94) or ΔE₀₀ (CIEDE2000) are used.

In practice it can happen that colors are present at the input of the system whose brightness is greater than the maximum possible value with the corresponding color type, or the color lies outside the color space that the screen can reproduce. With more than three color channels, the color space, compared with conventional screens, is greatly expanded. Therefore, in practice most colors lie within the reproducible color space. For colors that nonetheless are outside, variants of the so-called Gamut Mapping Procedure can be used. For example, this can be a procedure in which the color is represented onto the surface of the color body in the direction of the gray axis with the same color tone. Such procedures are generally known and can be used additionally in the invention-specific processing.

For filling in the color type tables, a multiplicity of various alternatives can be used. The suggested procedures are basically divided into two different formulations, a purely stochastic search of control vectors S that are optimized according to a defined error criterion, or setup of a solution through linear superposition of solutions of three primary valences, or of two primary valences and white.

First the last version will be depicted in greater detail. It is assumed that the sum of the primary valences with full triggering generates a defined white W^{(B)} of the screen, such as that of light type D65:

W^{(B)}=P₁^{(B)}+ . . . P_{N}^{(B)}

We further refer to the exemplary arrangement of color types of primary valences Pᵢ^{(B)} in the UCS color table as per FIG. 2, where six color channels are assumed. Generally a normal observer or an average observer from a number of different observers is assumed as the reference observer. Now let us assume that a color type corresponding to the color valence F^{(B)} is to be depicted on the screen, where its brightness at first is to be assumed as Y^{(B)}=1.0. For filling in the color table, for this the color types in {u′,v′} coordinates, and the pertinent control signals Si(B) and a maximum brightness Y^{(B)}ₘₐₓ attainable, are to be determined. For this, first those of the color valence F^{(B)} at the adjacent primary valence are sought, which with the white point W^{(B)} form a triangle in the color type table. In the example, these are the primary valences 2 and 3. In a first step, a solution is sought for the equation

F^{(B)}=a₁P₂^{(B)}+b₁P₃^{(B)}+c₁W^{(B)}

where the variables a₁, b₁ and c₁ always yield positive values or zero. Linear matrix operations thus are used for the computation. All triggering values must lie between 0 and 1.0, i.e., the strongest primary valence in the solution can at maximum contain the triggering value 1.0. Therefore, in the solution for the variables, all are proportionally increased or decreased until the largest value is exactly 1.0.

The result of the triggering is depicted in FIG. 3, upper row. In the left diagram on the ordinate, the triggering values of the primary valences P₁ to P₆ are depicted, and in the right diagram the resulting brightness Y^{(B)} for this solution. However, the greatest possible brightness is not achieved with this, since there are still further solutions through a combination of still other unused primary valences, that additionally can be used. Also, the primary valence P₂ is not yet fully used. Therefore, in a second step, a possible mixture of the primary valences P₂ and, for example, the primary valence P₄ lying to the right of P₃ and the sum of the remaining primary valences is sought without the already “consumed” fully triggered primary valence P₃. The attained triggering values are then proportionally adapted so that also the primary valence P₂ is not triggered above the value of 1.0, or the triggering share of other primary valences do not become negative. The sum of both solutions in the example yields the triggering as per FIG. 3, middle row, in which the brightness has risen further. With this also, all possibilities are not yet exhausted. True, primary valences P₂ and P₃ are now fully triggered, but a mixture of the primary valences P₁ and P₄ with the sum of the still not consumed remaining primary valences can still be exploited for a further mixing share. This produces the result in FIG. 3, lower row. According to this step, the possible mixing contribution of the superposition of remaining primary valences is summoned. Further mixing trials would lead for this example only to negative solutions for the triggering, i.e., for this algorithm the end has been reached. However, in practice, depending on the color location of the investigated color, it can happen that up to 5 steps are necessary before all possibilities for superposition of solutions have been exhausted. As its result, the procedure always delivers a compact maximum possible triggering of primary valences with the center of the color type to be depicted with a maximum brightness. This solution is similar to the so-called optimal colors, that for a closed band in the spectral region that can also be closed via the spectral edge in the infinite, for pre-set saturation and color tone, attain the greatest brightness, but it is not identical.

For setting up the table, systematically all possible color types are assumed in a preset quantization as addresses, and then for this the pertinent triggering shares are calculated as control vectors S(B) with the triggering limit for Y^{(B)}ₘₐₓ and stored. According to the invention this table can then be used online as an LUT.

There are alternatives to the described procedure with a stepwise filling up of contributions of the primary valences with color tones in the vicinity of the color valence to be depicted. Starting with the most obvious, a general mathematical procedure can also be used, in which at first all solutions are precalculated with a still undetermined brightness for the color mixing of combinations of three primary valences. In the case of 6 color channels, that is 20 possible combinations. In a general case, the number of combinations for N color channels is computed with [1*2+2*3+3*4+ . . . (N−2)(N−2)]/2. In connection with this, for the boundary conditions that the triggering values overall for each primary valence must lie between 0 and 1.0, with the procedure of linear programming (constrained linear programming), a superposition of all solutions so determines that a maximum possible brightness value Y^{(B)} is achieved.

Another procedure for filling in the table likewise functions by using linear matrix operations and the reference to an arbitrarily defined observer. With this procedure, only four steps are necessary.

The maximum brightness of the display for a preset {u′,v′} color type is achieved when this color is found on the surface of the screen color body. The color body surface is reached when channels are not or are fully triggered and a maximum of two channels are variably triggered. Additionally, the fully or not triggered channels lie together in block fashion, whereby a connection of the blocks via the spectral edges is enclosed. All combinations of fully or non-triggered channels form extreme points on the color body surface. The connections of the adjoining extreme points form triangles. Thus it becomes possible to describe the surface by way of 2N(N−1) triangles. All corners of the triangles, and thus the extreme points, are each the mixing colors of the primary valences of channels that lie next to one another in a block. In a limiting case, this core block consists of only one fully triggered channel (a switched-on primary valence) and in the other limiting case all the channels are fully triggered and thereby the white point of the screen is generated. Mixtures in which no channel is constantly fully triggered, describe triangles on the underside of the color body. These triangles run together in the black point of the color body. For example, for N−6 color channels, 60 triangles are produced. Of these, 2N triangles are on the underside of the color body, while the remaining 2N(N−1)−2N lie on the upper side. Only the upper ones are decisive, due to the sought maximum brightness. In this case, for N=6, consequently 48 triangles remain, which for example in FIG. 4 are sketched via their color value shares in the CIE 1976 UCS color table.

Let us give closer consideration as an example to triangle 1 limited by corners 4.1, 4.16 and 4.12. Corner 4.1 corresponds to the fully triggered primary valence of channel 1. The adjoining channels 2 and 6 are switched on as variable channels, with channel 6 to be considered as adjoining, closed via the edge of the visual spectrum in the infinite. If channel 6 is also fully triggered and channel 2 switched off, then corner 4.16 is reached through color mixing of the primary valences 1 and 6 with the color type 4.16. Accordingly the third corner is reached with color type 4.12, if channel 6 is switched off and channel 2 with color type 4.2 is fully switched on. All points in triangle 1 or on the edge are reached through variably triggered channels 2 and 6.

Generally in each triangle i we find a corner that is determined through a smallest number of fully triggered channels lying next to each other, the so-called core block, and the mixture of its primary valences. All colors αF^{(B)} in a triangle i (1≦i≦48) are then described generally by the equation

αF^{(B)}=α_{i,1}F_{i,1}^{(B)}+α_{i,2}F_{i,2}^{(B)}+F_{i,3}^{(B)}

with the coefficients α, α_{i,1} and α_{i,2}, whereby F_{i,3}^{(B)} depicts the color that is generated by the fully triggered channels in the core block. The colors F_{i,1}^{(B)} and F_{i,2}^{(B)} are the variable channels. All color valences and the pertinent color types of all corner points of the triangles can be precomputed, as described in what follows.

First, under each color type as an address of an LUT, the color F^{(B)} from the color type {u′,v′} for an arbitrarily selected brightness, equivalent to color value Y with Y=1.0, is computed. The solution of the above equation as per the coefficients next yields the maximum brightness value of this color Yₘₐₓ=α and the two variables α_{i,1} and α_{i,2}. These determine the triggering of the participating variable channels which adjoin the core block.

However, before this computation can be carried out, first the triangle i must be sought which encloses the color to be computed on the surface of the color body. This is conducted through a search process in the two-dimensional color table shown in FIG. 4. The initial point is the following determination equation for a color type {u′,v′} in an arbitrary triangle i with the designation {u_{Δ1}′,v_{Δ1}′}, {u_{Δ2}′,v_{Δ2}′}, {u_{Δ3}′,v_{Δ3}′} for the corners of the triangle:

$$( \begin{matrix}{u}^{′} \\ {v}^{′}\end{matrix} ) = ( \begin{matrix}{u}_{Δ 1}^{′} \\ {v}_{Δ 1}^{′}\end{matrix} ) + {k}_{1} ( \begin{matrix}{u}_{Δ 2}^{′} - {u}_{Δ 1}^{′} \\ {v}_{Δ 2}^{′} - {v}_{Δ 1}^{′}\end{matrix} ) + {k}_{2} ( \begin{matrix}{u}_{Δ1}^{′} - {u}_{Δ 1}^{′} \\ {v}_{Δ1}^{′} - {v}_{Δ 1}^{′}\end{matrix} ) ,$$

where k₁ and k₂ represent coefficients that must fundamentally meet the conditions
ti 0≦k₁≦0,0≦k₂≦1.0 and (k₁+k₂)≦1.0
if only the points within the triangle 1 are to be detected. The process of searching for the triangle in which a given color type {u′,v′} lies, then progresses so that the coefficients for all the triangles are determined with the inversion formula

$$( \begin{matrix}{k}_{1} \\ {k}_{2}\end{matrix} ) = {( \begin{matrix}{u}_{Δ 2}^{′} - {u}_{Δ 1}^{′} & {u}_{Δ 1}^{′} - {u}_{Δ 1}^{′} \\ {v}_{Δ 2}^{′} - {v}_{Δ 1}^{′} & {v}_{Δ 1}^{′} - {v}_{Δ 1}^{′}\end{matrix} )}^{- 1} \cdot ( \begin{matrix}{u}^{′} - {u}_{Δ 1}^{′} \\ {v}^{′} - {v}_{Δ 1}^{′}\end{matrix} )$$

and the triangle is sought out for which the coefficients k₁ and k₂ fulfil the conditions named above. The results of the then-computed coefficients α, α_{i,1} and α_{i,2} exactly determine the color reproduction for the basic observer within the depicted color space of the image reproduction device. The procedure runs very fast, since only simple matrix operations are used.

The solutions named above are particularly well suited for the control of colors in relation to a standardized or an average observer from a group of observers. If the colors are to be issued as optimized for a larger number of observers, then also an optimized control value can be determined for the screen with a stochastic search method.

With this the initial values, for M observers, for example, can be computed color values {X, Y, Z}^{(B)} or color types {u′,v′} that can be computed directly from the present spectral distribution of a color stimulus. For these colors, first, for an average observer with one of the procedures named above, a start vector S₀^{(av)} can be determined. In accordance with the basic diagram shown in FIG. 5, as a consequence small variations of the individual signal components can be generated in a stochastic generator 5.1, then added to the start vector in 5.2 and the color errors of the colors reproduced therefrom can be computed for all observers in 5.3. This keeps occurring until a minimum of the average or maximum color error of the observer results. For each stop, the attained result is compared with the most favorable of the previous steps. If the color error from one step is smaller than the previous one, it is stored in 5.5. This is repeated until it goes lower than a desired threshold value or a time limit is reached. With this procedure, the best possible results can be attained for all observers, if certain spectral distributions of the colors are present in divisible classes. For each class of spectral distributions of colors, a particular optimized table can be computed. For example, print colors, water colors, or other paint colors or natural colors of a landscape can be named. For general spectral distributions in which very strongly differing metameric spectral distributions are present for a color valence, the procedure is not applicable with an LUT, since then individual optimization would have to be done for each spectral distribution.

We point out that the computing procedures depicted in the description of the figures with specific numbers of color channels do not limit the invention in its overall significance. We likewise point out that by an image reproduction device what is understood is any device customary in the state of the art for direct or indirect representation of colored images or films, in which through mixing of multiple basic colors, the one indicated are produced. Here we name as examples, and not to be conclusive, monitors, television devices and video projectors.

In all, thus here a procedure is presented for triggering an electronic image reproduction device with N>3 individually controllable color channels, through which N primary colors are defined, from which the colors are additively mixed. Such image reproduction procedures are used to increase the depictable color space and, with a greater number of degrees of freedom, with the color mixing, to attain an adaptation of the color reproduction to more differing human observers. The various, and in part already known, computational procedures for an optimized color mixing with N>3 color channels are very time-consuming mathematically and not usable in real-time processing for image reproduction. Therefore, according to the invention, we propose using one or more precomputed two-dimensional tables for real-time processing, in which under the addresses of a color type of the color to be reproduced, the values necessary for control of N color channels are stored and retrieved in operation. To spare additional computing time, we suggest that the maximum possible brightness for a color type be stored through the reproduction process, together with the control values for this brightness. In operation, the control values are obtained for a less bright color by simple restandardization from the values for the maximum brightness. According to the invention, to fill up the tables, we propose iterative computation of control values with the superposition of linear programming or stochastic optimization from pre-set spectral color stimuli functions, XYZ or RGB values, whereby the optimization may take place as per the spectral characteristics of the colors to be depicted, as per determined color classes or as per various observers. In advantageous fashion, the selection of the particular table in operation is controlled as per the characteristics of the inputted color information or the values outputted by tables run in parallel, are converted with a model of color reproductions into color values, from them color errors of reproduction are determined for one or more observers, and the most favorable control vector is selected after that.

It is also understood that the features of the invention named above are applicable not only in the particular combination indicated, but also in other combinations or singly, without departing from the framework of the invention.

1. Procedure for triggering an electronic image reproduction device, whereby:
1.1 the image reproduction device is run with N>3 individually adjustable color channels,
1.2 the reproduced colors are carried out by an additive mixing of N color channels with N assigned primary valences (intensities), and
1.3 optionally an additional brightening of the perceived color is controlled by a white brightening channel,
characterized in that
1.4 before operating, a Look-up Table (LUT) is compiled, whose addresses correspond to a color type and under each address a control vector is stored with N control signals for the control of N channels of the screen at maximum possible brightness for this color type,
1.5 in operation, for controlling the N color channels for a color of given brightness to be reproduced, at first the color type is computed so that the LUT is addressed, and the control vector of the LUT found at this address is used for the control signals for the N color channels.

2. Procedure according to the above patent claim 1, characterized in that the LUT is configured as a two-dimensionally-addressed LUT for the color types {u′,v′} of the CIE 1976 UCS color table.

3. Procedure according to claim 1 above, characterized in that an internal linearization is used for a linear connection between input signals of the image reproduction device and the generated color values.

4. Procedure according to claim 1, characterized in that before operation, in the LUT at the addresses of the color types, a pertinent maximum brightness value is also stored, and in operation, for controlling the N color channels of the control vector of the LUT found at this address, is multiplied by the relation of the given brightness of the color to the stored maximum brightness value, and is issued as control signals for the N color channels.

5. Procedure according to claim 1, characterized in that the particular maximum brightness value for the color type according to the basic spectral value curves of a preset observer are computed from the stored signal values and from a reproduction model of the screen.

6. Procedure according to claim 1, characterized in that in the LUT, the color types are determined for a multiplicity of defined observers, where the observers are defined from their individual basic spectral value curves.

7. Procedure according to previous patent claim 6, characterized in that at least one defined observer is the normal observer as defined by the CIE.

8. Procedure according to claim 1, characterized in that for or image types with special color or spectral characteristics of the colors, a separate LUT is compiled and this is stored in parallel and depending on the recognized image type, the control vectors are taken from the corresponding LUT.

9. Procedure according to claim 1, characterized in that for various observers, an LUT is compiled and is stored in parallel, and depending on the observer or group of observers present, the control vectors are taken from the corresponding LUT.

10. Procedure according to claim 9, characterized in that the triggering vectors stored in the LUT are derived from the weighted superposition of solutions for mixing of the color type from three primary colors of the screen, and this weighted superposition of solutions from all possible combinations of three primary colors is optimized so that a maximum possible brightness is attained with the given color type.

11. Procedure according claim 10, characterized in that the optimization takes place iteratively.

12. Procedure according to one of the previous patent claim 10, characterized in that the optimization takes place through linear programming.

13. Procedure according to claim 1, characterized in that the control vectors for a color type at maximum possible brightness of the reproduced color are determined from triangles on the surface of the color body of a screen, where the corners of the triangles are given through extreme points, which, through the mixing of the primary colors a number of K color channels with 1≦K≦N at full triggering are determined, and the spectral distributions of the K color channels lie next to each other in the spectral range, and all other (N−K) color channels are switched off.

14. Procedure according to claim 13, characterized in that for preset classes of spectral distributions of colors to be reproduced, proceeding from a start vector, a stochastic optimization of triggering values is carried out as per the minimum color errors for a group of observers, and the start vector is derived from the weighted superposition of solutions for mixing of the color type from three primary colors of the screen, and this weighted superposition of solutions from all possible combinations of three primary colors is optimized so that a maximum possible brightness is attained with the given color type.

15. Procedure according to claim 14, characterized in that for preset classes of spectral distributions of colors to be reproduced, proceeding from a start vector, a stochastic optimization of triggering values is carried out according to the minimum color error for a group of observers, and the start vector is determined for a color type with maximum possible brightness of the reproduced color from triangles on the surface of the color body of a screen, whereby the corners of the triangles are given through extreme points, which are determined through the mixing of the primary colors of a number of K color channels with 1≦K≦N at full triggering, and the spectral distributions of the K color channels lie next to each other in the spectral range and all other (N−K) color channels are switched off.

16. Procedure according claim 13, characterized in that for preset classes of spectral distributions of colors to be reproduced, proceeding from a starting vector, a stochastic optimization of triggering values is carried out according to the minimum color error for a group of observers, and the start vector is computed from a spectral adjustment to a color stimulus to be reproduced according to the least error squares method, via a model of the color reproduction.

17. Procedure according to claim 14, characterized in that the group of observers corresponds to a representative cross section of human observers.

18. Image reproduction device with a storage medium attached to a computer, characterized in that at least one computer program or program module is stored on it, which in one embodiment, carries out the procedure on the computer as per procedural claim 1.

19. Storage medium, integrated into a computer or for a computer of an image reproduction device, characterized in that at least one computer program or program module is stored on it, which in one embodiment, carries out the procedure on the computer according to procedural claim 1.

20. Triggering procedure according to claim 1, characterized in that multiple LUTS are present in parallel, which are optimized according to the spectral characteristics of colors or for various observers (standardized or non-standardized observers), and one LUT is selected in lump-sum fashion for an image or an image point, and the selection criterion can be determined according to the characteristics of the optimization of the LUT and the characteristics of the color to be represented.

21. (canceled)
